(19) United States
(12) Patent Application Publication
(10) Pub. No.: US 2013/0140320 A1
(43) Pub. Date: Jun. 6, 2013

(54) Containers and Overwraps Comprising Thermoplastic Polymer Material, and Related Methods for Making the Same

(71) Applicants: Krishna V. Nadella, Redmond, WA (US); Thomas Malone, Bellingham, WA (US); Barbara Burke, Bothell, WA (US); Steven Woolridge, Mukilteo, WA (US)

(72) Inventors: Krishna V. Nadella, Redmond, WA (US); Thomas Malone, Bellingham, WA (US); Barbara Burke, Bothell, WA (US); Steven Woolridge, Mukilteo, WA (US)

(73) Assignee: MICROGREEN POLYMERS INC., Arlington, WA (US)

(21) Appl. No.: 13/817,417

(22) PCT Filed: Aug. 18, 2011
(86) PCT No.: PCT/US11/48270

§ 371 Date: Feb. 15, 2013

Related U.S. Application Data
(60) Provisional application No. 61/401,730, filed on Aug. 18, 2010.

(51) Int. Cl. B65D 81/38; B31C 99/00

(52) U.S. Cl. CPC B65D 81/3879; B31C 13/00
USPC 220/737; 493/269

(57) ABSTRACT

A container comprises a wall and a bottom. The wall includes a thermoplastic polymer material, and forms a cylindrical shape. The thermoplastic polymer material has a microstructure that includes a plurality of closed cells, each cell containing a void and each cell having a maximum dimension extending across the void within the cell that ranges between 1 micrometer and 200 micrometers long. The bottom is joined to an end of the cylindrical shape to close the end such that the beverage and/or other items disposed inside the cylindrical shape don't escape through the end of the shape.

### CROSS REFERENCE TO RELATED APPLICATION AND CLAIM OF PRIORITY

This application claims priority from commonly owned U.S. Provisional Patent Application 61/401,730 filed 18 Aug. 2010, and titled “Expanded Microcellular Plastic Cups and/or Containers, And Methods for Making The Same”, presently pending, which is incorporated by reference.

### BACKGROUND

Disposable containers, such as cups for holding a beverage, boxes for holding liquids and other items, and bowls for holding liquids and other items, are made from a variety of natural and/or synthetic materials by thermoforming, injection molding, and/or convolute forming the materials into a desired shape. For example, such containers are often made of paper, poly-coated paper, expanded plastics and solid plastics, such as polyethylene terephthalate (PET), high density polyethylene (HDPE), polystyrene (PS), EPS (expanded polystyrene), and polypropylene (PP). Depending on their purpose and function, such containers come in various shapes and sizes, with or without a lip, and may include a single or multi-layered wall, and/or an overwrap. And depending on the type of material used and on their design and construction, these containers exhibit various properties and attributes considered desirable or undesirable based on a range of performance and economic parameters including thermal insulation, strength, sturdiness, printability, shelf-life, microwavability, biodegradability, compostability, recyclability, and ease and/or cost of manufacture.

Most of these containers have advantages as well as disadvantages. For example, disposable cups made from EPS (expanded polystyrene) material are excellent thermal insulators that keep the inside contents hot or cold for a long time without affecting the outside contact surface. However, EPS cups are not biodegradable, compostable or recyclable, and their uneven surface makes high-quality graphic printing difficult.

As another example, single-walled paper cups are fairly biodegradable but poor insulators. For handling hot beverages, double cups or a cup sleeve is often used, but using these causes additional expense for the beverage vendor.

Single-walled plastic cups made of solid plastics tend to be poor thermal insulators and lack rigidity for easy handling. Because they are thermoformed or formed by injection molding, printing is done after the cups are formed, which is complicated and expensive. Some types of plastic cups are designed to keep food longer. For example, plastic containers with HDPE act as moisture and oxygen barriers that extend the shelf life of the food. Some types of plastic cups are designed to be used in microwaves. For example, plastic cups made from polypropylene tolerate high heat often generated while microwaving a food and/or beverage.

Multi-layered cups are single-walled paper or plastic cups enclosed with an insulated overwrap that consists of two layers, an embossed or corrugated sheet glued to one side of a larger size flat sheet made of similar or dissimilar material as the cup. The overwrap is wrapped around the cup such that the corrugated side, which acts as an insulator, is sandwiched between the cup and the flat sheet. These types of cups are designed to provide more insulation and be sturdier. They are printable, microwavable, and may be produced with recyclable materials. However, multi-layered cups require more assembly steps and an extra layer of insulated material, which adds to the cost of the product.

### SUMMARY

In an aspect of the invention, a container comprises a wall and a bottom. The wall includes a thermoplastic polymer material, and forms a cylindrical shape. The thermoplastic polymer material has a microstructure that includes a plurality of closed cells, each cell containing a void and each cell having a maximum dimension extending across the void within the cell that ranges between 1 micrometer and 200 micrometers long. The bottom is joined to an end of the cylindrical shape to close the end such that the beverage and/or other items disposed inside the cylindrical shape don't escape through the end of the shape.

In another aspect of the invention, an overwrap comprises a body having a cylindrical shape and configured to surround a portion of a container. The body includes a thermoplastic polymer material having a microstructure that includes a plurality of closed cells (microcellular hubbies), each cell containing a void and each cell having a maximum dimension extending across the void within the cell that ranges between 1 micrometer and 200 micrometers long.

With the many microcellular bubbles in the material's microstructure, the amount of material used to construct a container or an overwrap is less than the amount of material used in conventional disposable single-walled and disposable multi-walled paper/plastic containers. In addition, the many microcellular bubbles provide a container or overwrap insulating qualities and stiffness that are superior to conventional disposable single-walled and disposable multi-walled paper/plastic containers. If a smooth skin is included in the microstructure, then the material can be appealing to the touch, and allow high-quality graphics to be printed on its surface. Furthermore, because the microcellular bubbles are closed, the material and microstructure are leak-resistant and thus prevent liquids from wicking throughout the material.

### BRIEF DESCRIPTION OF THE FIGURES

FIG. 1 is a photograph of a cross-section of a portion of a thermoplastic material having a closed-cell microstructure that is included in the containers and overwraps in FIGS. 2A-9, according to an embodiment of the invention.

FIG. 2A is a perspective view of a container, according to an embodiment of the invention.

FIG. 2B is a partial cross-sectional view the container in FIG. 2A, according to an embodiment of the invention.

FIG. 3A is a plan view of a wall of the container in FIG. 2A, according to an embodiment of the invention.

FIG. 3B is a perspective view of a bottom of the container in FIG. 2A, according to an embodiment of the invention.

FIG. 3C is a plan view of an alternative bottom, according to another embodiment of the invention.

FIG. 4 is a perspective view of the wall in FIG. 3A being formed into a cylindrical shape, according to an embodiment of the invention.

FIG. 5 is a perspective view of a container, according to another embodiment of the invention.

FIG. 6 is a perspective view of the container in FIG. 5 being formed into a cylindrical shape, according to an embodiment of the invention.

FIG. 7A is a perspective view of an overwrap, according to an embodiment of the invention.

FIG. 7B is a partial, cross-sectional view of the overwrap in FIG. 7A, according to an embodiment of the invention.

FIG. 8A is a perspective view of a container with an overwrap joined to it, according to an embodiment of the invention.

FIG. 8B is a cross-sectional view of a container with an overwrap joined to it, according to another embodiment of the invention.

FIG. 8C is a cross-sectional view of a container with an overwrap joined to it, according to yet another embodiment of the invention.

FIG. 8D is a cross-sectional view of a container with an overwrap joined to it, according to still another embodiment of the invention.

FIG. 9 is a cross-sectional view of a container with an overwrap joined to it, according to another embodiment of the invention.

FIG. 10 is a perspective view of another container, according to an embodiment of the invention.

FIG. 11 is a schematic view of a process for generating a closed-cell microstructure in a thermoplastic material such as that shown in FIG. 1, according to an embodiment of the invention.

### DETAILED DESCRIPTION

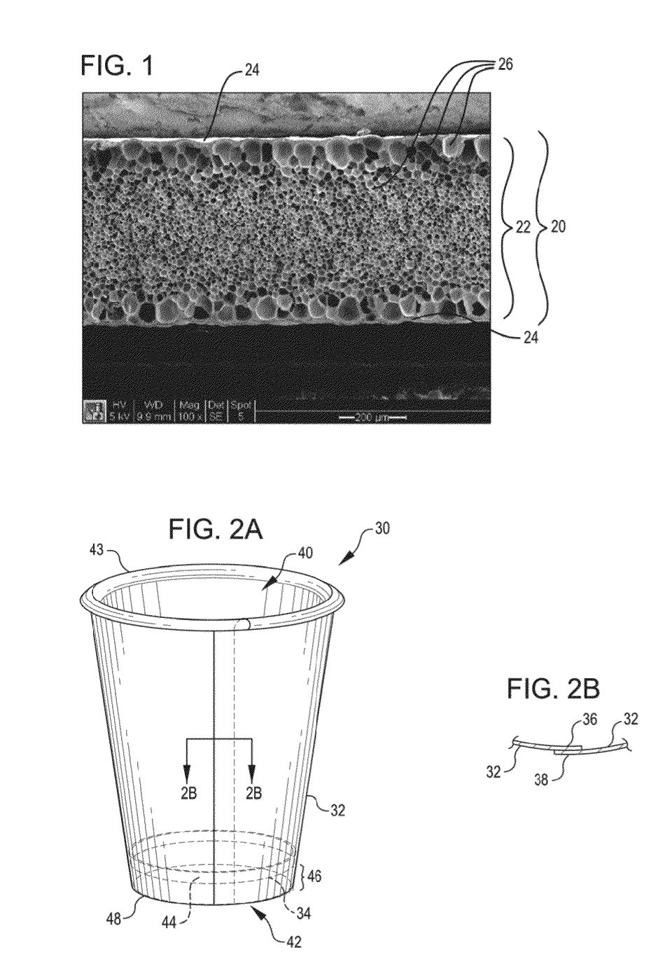

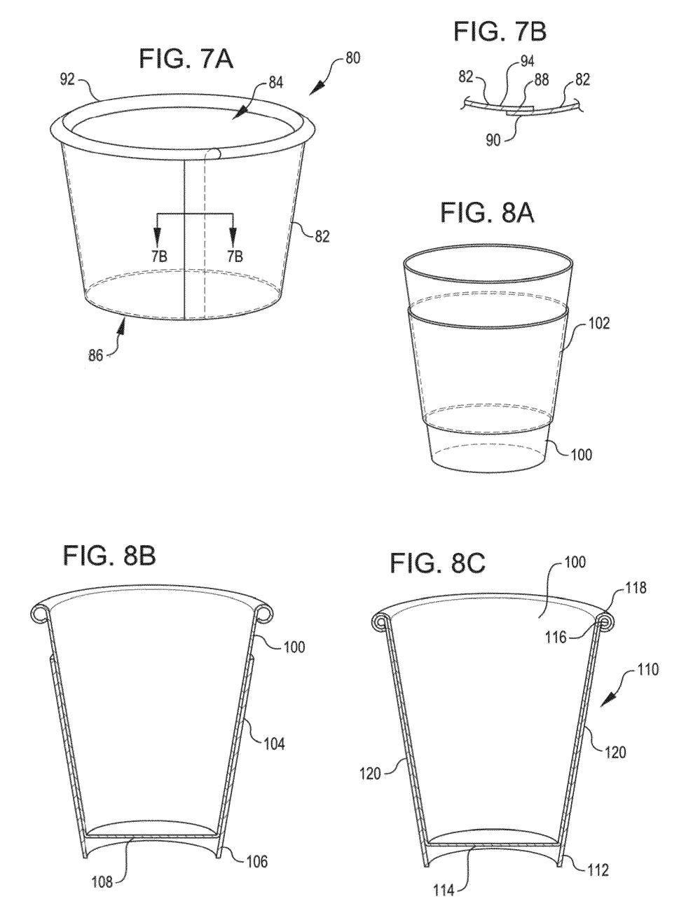

The containers (discussed in greater detail in conjunction with FIGS. 2A-6) and the overwraps (discussed in greater detail in conjunction with FIGS. 7A-9) are examples of a few embodiments of the invention disclosed and claimed in this patent application. Each container and overwrap includes a thermoplastic polymer material that has been expanded at a microcellular level by a process (discussed in greater detail in conjunction with FIG. 10) to generate a microstructure (discussed in greater detail in conjunction with FIG. 1) that includes many microcellular bubbles. Expanded microcellular thermoplastic polymer materials include closed-cell thermoplastics with a large number of small bubbles. Typically, the bubbles or cells are of the order of 0.1 to 100 micrometers in diameter, and there are 10⁸ or more cells per cubic centimeter (cm³) in the microcellular structure. The bubbles reduce the density of the solid material from which the expanded microcellular thermoplastic material is made, and thus reduce the amount of material used in an application.

FIG. 1 is a photograph of a cross-section of a portion of a thermoplastic polymer material 20 that containers and overwraps may include, according to an embodiment of the invention. In this and certain other embodiments, the material 20 includes a closed-cell microstructure 22, and a skin 24. The closed-cell microstructure includes many microcellular bubbles 26 (only three labeled for clarity) whose cell sizes typically range from 0.1 to 200 micrometers and are closed. These many bubbles 26 form a core that is sandwiched between the skins 24. Each skin 24 is a smooth, outer-layer whose microstructure does not include microcellular bubbles or at most far fewer bubbles than the core's microstructure. In this and other embodiments, each skin 24 is integral to the closed-cell microstructure 22. More specificaliy, each skin 24 and microstructure 22 are formed during a single process, such as that shown and discussed in conjunction with FIG. 10, and from the same initial sheet of solid thermoplastic material. In other embodiments, the skin may not be integral to the dosed-cell microstructure 22, but formed after the microstructure 22 has been formed.

With the many microcellular bubbles in the core's microstructure, the processed material is substantially thicker than and has a cross-sectional area substantially greater than, the material before it was processed. Hence, when such processed material is used to construct a container or an overwrap, less material may be used than in conventional disposable single-walled and disposable multi-walled paper/plastic containers. In addition, the many microcellular bubbles provide a container or overwrap insulating qualities and stiffness that are superior to conventional disposable single-walled and disposable multi-walled paper/plastic containers. With a smooth skin, the material is not only aesthetically pleasing and appealing to the touch, but also can allow high-quality graphics to be printed on its surface. Furthermore, because the microcellular bubbles are closed and the skins are smooth, the material and microstructure are leak-resistant and thus prevent liquids from wicking into and throughout the material.

The thermoplastic polymer material may be any desired material. For example, in this and certain other embodiments the thermoplastic polymer material includes polyethylene terephthalate (PET). In other embodiments, the thermoplastic polymer material may include one or more of the following: polylactic acid (PLA), polystyrene (PS), polycarbonate (PC), and a bioplastic such those made by Cereplast Inc.

The cell sizes of the thermoplastic polymer material may be any desired size. For example, the cells 26 of a specific microstructure may range in size between 100 to 500 micrometers. In other examples, the cells 26 of a specific microstructure may range in size between 0.1 to 100 micrometers. Different cell sizes can be obtained by using various processing methods. For example, an extrusion process can be used to produce expanded plastics that have a cell size of conventional foams, such as greater than 200 micrometers. In such a process, solid thermoplastic granules are fed into an extruder along with a chemical additive or physical blowing agent and mixed together under high pressure and temperature to form a molten solution. The polymer gas solution is subsequently ejected out of a die to expand into a cellular structure that has many closed-cells and/or open-cells and that is then formed and/or cut into the desired dimensions.

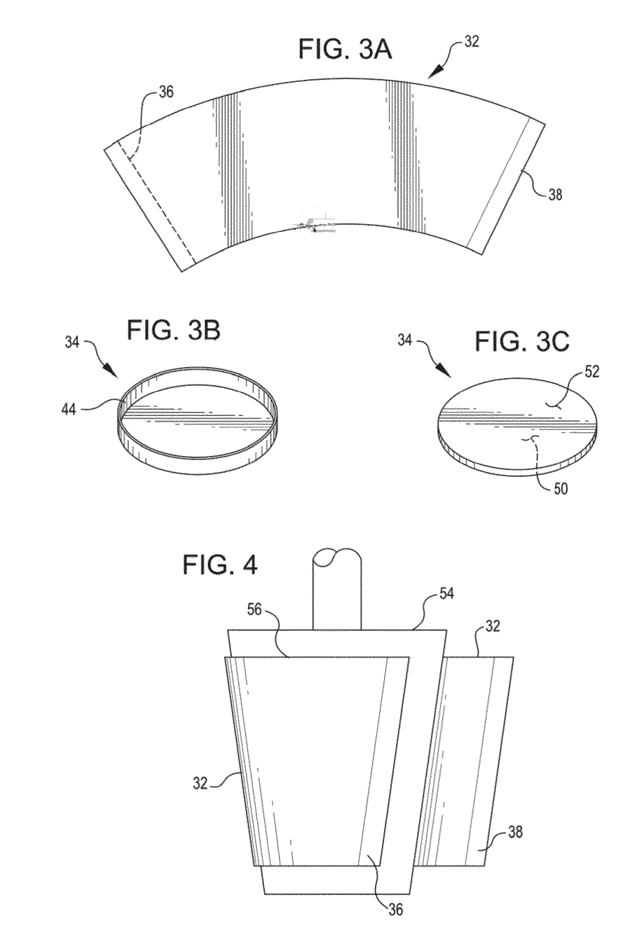

FIG. 2A is a perspective view of a container 30, according to an embodiment of the invention. FIG. 2B is a partial cross-sectional view the container 30 in FIG. 2A, according to an embodiment of the invention. FIG. 3A is a plan view of a wall 32 of the container 30 in FIG. 2A, according to an embodiment of the invention. FIG. 3B is a perspective view of a bottom 34 of the container 30 in FIG. 2A, according to an embodiment of the invention. FIG. 3C is a plan view of an alternative bottom 36, according to another embodiment of the invention. And FIG. 4 is a perspective view of the wall 32 in FIG. 3A being formed into a cylindrical shape via convolute forming, according to an embodiment of the invention.

Referring to FIG. 2A, the container 30 includes a wall 32, and a bottom 34. In this and certain other embodiments, both the wall 32 and the bottom 34 include a thermoplastic polymer material that has a microstructure as discussed in conjunction with FIG. 1. More specifically, the microstructure includes a plurality of closed cells 26 (FIG. 1), each cell 26 containing avoid and each cell 26 having a maximum dimension extending across the void within the cell 26 that ranges between micrometer and 200 micrometers long. In other embodiments, each cell 26 may have a maximum dimension extending across the void within the cell 26 that ranges between 1 and 50 micrometers. With a smooth integral skin 24 (FIG. 1), one can print or emboss the surface of the wall 32 and/or bottom 34 that is exposed to a user to provide the user information, such as advertising.

The shape of the container 30 may be any desired shape. For example, in this and certain other embodiments the shape is cylindrical. More specifically, the shape of the container 30 includes an inverted truncated cone. In other embodiments, the shape may include a truncated cone in which the opening of the container is smaller than the bottom. In still other embodiments, the shape may be cylindrical with a rectangular cross-section, such as a pyramid.

Referring to FIG. 2B, to form the wall 32 of the container 30, a first portion 36 of the wall 32 is joined to a second portion 38 of the wall 32. The two portions 36 and 38 may be joined to each other by any desired means. For example, in this and certain other embodiments, an adhesive (not shown) between the first and second portions 36 and 38, respectively, fastens the two portions together to form an inverted, truncated cone having a first end 40 and a second end 42. In this and certain other embodiments, the first end 40 includes a lip 43 to facilitate drinking and/or pouring from the container 30. In other embodiments, an agent disposed between the two portions 36 and 38 may seal the two portions 36 and 38 to each other when heated to an activating temperature. In still other embodiments, the portions 36 and 38 may be fused together by melting the skin 24 (FIG. 1) of either or both portions 36 and 38, and then exerting pressure on the portions to cause the melted material in the skins to coalesce. An example of such a fusion process is described in PCT patent application PCT/US11/33075, filed 19 Apr. 2011, titled “A METHOD FOR JOINING THERMOPLASTIC POLYMER MATERIAL”, hereby incorporated by reference.

The bottom 34 may be joined to the wall 32 by any desired means that closes the end 42 of the inverted, truncated cone and prevents a liquid, such as a beverage, and/or other items from escaping the container through the end 42. For example, in this and certain other embodiments, an adhesive (not shown) between the perimeter 44 (also shown in FIG. 3B before being folded inward) of the bottom 34 and the wall 32 fastens the bottom 34 and the wall 32 together. In other embodiments, an agent disposed between the perimeter 44 and the wall 32 may seal the two to each other when heated to an activating temperature. In still other embodiments, the perimeter 44 and the wall 32 may be fused together as described in the above-referenced PCT patent application PCT/US11/33075.

The bottom 34 may also be located anywhere desired in the end 42. For example in this and certain other embodiments, the bottom is located in the end 42 such that the end 42 forms a skirt 46. In other embodiments, the bottom 34 may be located flush with the end 42. The skirt 46 may be desirable because it makes the bottom 34 a false bottom, which allows the container 30 to be easily de-nested or removed from its immediately adjacent neighbors in a stack of such containers. In addition, the skirt 46 allows the container 30 to remain stable when set on a surface (not shown) that is not perfectly flat. It does this by allowing much of the skirt's edge 48 to remain in contact with the surface while the contour of the surface surrounded by the skirt 46 rises toward the bottom 34. In such a situation, if the container 30 didn't include the skirt 46, the high point of the surface would contact the bottom 34 and either cause the cup to tip over and spill its contents, or to lean or tip toward such an unbalanced position.

Referring to FIG. 3C, the container 30 may include an alternative bottom 36 that can be any desired material. For example, the bottom 36 may be a clear, solid thermoplastic material, or a solid thermoplastic material with a solid-color coating on its facing. Furthermore, the bottom 36 can be thermoformed or extruded to the desired shape and size. A bottom 36 that is clear has both a utilitarian and aesthetic function. Because its transparent, the contents of the container 30 may be viewed from outside the container 30. This also allows one to view any text and/or graphics, such as advertising, that may be printed or embossed on either the outer surface 50 or inner surface 52 of the bottom 36. Hence, either of the surfaces 50 and 52 may be printed or embossed with texts or graphics (such as a trademark) and can function as a place reserved for such a purpose. In addition, the bottom 36 may increase the stiffness of the whole container by being sufficiently rigid to withstand loads that would cause a conventional paper bottom to bend and/or buckle.

A solid bottom 36 or a foamed bottom 34 having a colored coating also has a practical and ornamental purpose. The coating can be used to help identify the contents, size and recyclability of a container 30. Furthermore, the color may itself provide users an aesthetically new user experience.

Referring to FIG. 4, convolute forming the container 30 involves assembling the container 30 from flat components. In this and certain other embodiments, the first step in the process is to generate in a sheet of thermoplastic material the microstructure discussed in FIG. 1, which has a core that includes many microcellular bubbles, and smooth integral skins that sandwich the core. Then, an arc-shaped wall 32 (FIG. 3A) is cut from the sheet and formed into a truncated cone by wrapping the arc-shaped wall 32 around a mandrel 54 and joining the portions 36 and 38 of the arch-shaped wall 32 to each other as previously discussed. Next, the bottom component 34 is joined to the wall 32 of the newly formed truncated, inverted cone as previously discussed. For embodiments that include a lip 43, the top edge 56 of the arc-shaped wall 32 may be rolled outwardly, either before or after the arc-shaped wall 32 is wrapped around the mandrel 54, to form the lip 43.

Like other existing disposable, convolute-formed, single-walled paper cups and containers, the arc-shaped wall 32 may have text or a graphic printed on it before the wall 32 is assembled with the bottom 34 to form the container 30. But, with a microstructure as discussed in conjunction with FIG. 1, the container 30 is stronger than and provides more thermal insulation for comfortable handling and for keeping contents hot or cold, than the typical disposable, single-walled paper cups and containers.

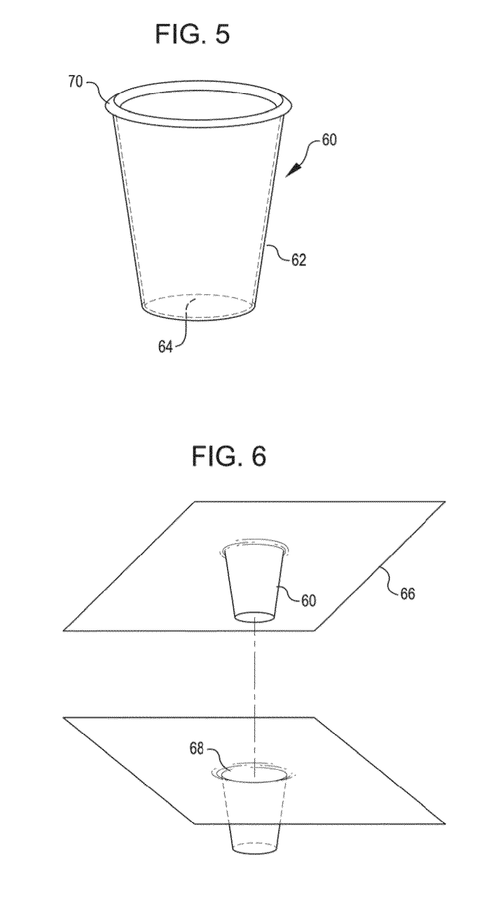

FIG. 5 is a perspective view of a container 60, according to another embodiment of the invention. FIG. 6 is a perspective view of the container 60 in FIG. 5 being formed via thermoforming into a cylindrical shape, according to an embodiment of the invention.

Referring to FIG. 5, the container 60 includes a wall 62, and a bottom 64. In this and certain other embodiments, both the wall 32 and the bottom 64 include a thermoplastic polymer material that has a microstructure as discussed in conjunction with FIG. 1. More specifically, the microstructure includes a plurality of closed cells 26 (FIG. 1), each cell 26 containing avoid and each cell 26 having a maximum dimension extending across the void within the cell 26 that ranges between 1 micrometer and 200 micrometers long. In other embodiments, each cell 26 may have a maximum dimension extending across the void within the cell 26 that ranges between 1 and 50 micrometers. With a smooth integral skin 24 (FIG. 1), one can print or emboss the surface of the wall 32 and/or bottom 34 that is exposed to a user.

The shape of the container 60 may be any desired shape. For example, in this and certain other embodiments the shape is cylindrical. More specifically, the shape of the container 60 includes an inverted truncated cone. In other embodiments, the shape may include a truncated cone in which the opening of the container is smaller than the bottom. In still other embodiments, the shape may be cylindrical with a rectangular cross-section, such as a pyramid.

Referring to FIG. 6, thermoforming the container 60 involves plastically deforming a sheet of material into the desired shape of the container. In this and certain other embodiments, the first step in the process is to generate in a sheet 66 of thermoplastic material the microstructure discussed in FIG. 1, which has a core that includes many microcellular bubbles, and smooth integral skins that sandwich the core. Then, the sheet 66 is heated to a temperature at which the material can be plastically deformed. Next, the heated sheet 66 is fed to a forming station where the sheet is pulled inside a mold 68 to form the desired shape of the container 60. For embodiments that include a lip 70 (FIG. 5), the mold 68 may include a profile to form the lip 70. Next, the container 60 is cooled to prevent further plastic deformation of the material and thus retain the shape that the mold 68 imparted to the sheet 66. Then, the container 60 is cut from the sheet 66 and may be trimmed to complete the container 60.

If the container 60 is to include text and/or a graphic on the wall 62, then the text and/or graphic may be applied to the wall 62 via a conventional in-mold labeling process. This process includes inserting a sheet (not shown) that has the desired text and/or graphic, between the mold 68 and the sheet 66 before the sheet 66 is pulled inside the mold 68; and then pulling both sheets into the mold 68 to generate the container 60 with the text and/or graphic on the wall 62.

Because the thermoformed container 60 includes material having a microstructure as discussed in conjunction with FIG. 1, the container 60 is stiffer than conventional, disposable, thermoformed cups, and provides more thermal insulation than conventional thermoformed cups. Thus, the container 60 can keep contents hot or cold longer than conventional, disposable thermoformed cups, and can keep one's hands better insulated from the temperature of the container's contents.

Other embodiments are possible. For example, containers that include a thermoplastic polymer material having a microstructure as discussed in conjunction with FIG. 1 can also be made via injection molding and/or blow molding. As another example, a container 60 may be thermoformed as previously discussed and then cut to remove its bottom 64 so that a bottom 36 (FIG. 3C) may be joined as previously discussed.

FIG. 7A is a perspective view of an overwrap 80, according to an embodiment of the invention. FIG. 7B is a partial, cross-sectional view of the overwrap 80 in FIG. 7A, according to an embodiment of the invention. The overwrap 80 may be joined, releasably or fixedly, to a wall of a container, such as the wall 32 (FIG. 2A) of the container 30 (FIG. 2A) or the wall 62 (FIG. 5) of the container 60 (FIG. 5), to provide additional thermal insulation, strength, stiffness, and/or a surface on which text and/or a graphic may be printed.

Referring to FIG. 7A, the overwrap 80 includes a body 82. In this and certain other embodiments, the body 82 includes a thermoplastic polymer material that has a microstructure as discussed in conjunction with FIG. 1. More specifically, the microstructure includes a plurality of closed cells 26 (FIG. 1) sandwiched between smooth, integral skins 24 (FIG. 1). Each cell 26 contains a void and has a maximum dimension extending across the void within the cell 26 that ranges between 1 micrometer and 200 micrometers long. In other embodiments, each cell 26 may have a maximum dimension extending across the void within the cell 26 that ranges between 1 and 50 micrometers. With a smooth, integral skin, one can print or emboss the surface of the body 82 that is exposed to a user.

Because the overwrap 80 includes material having a microstructure as discussed in conjunction with FIG. 1, the overwrap 80 can provide more strength, more stiffness, and/or more thermal insulation to a disposable, single-walled container than a conventional cup having a multi-layered wall. Consequently, containers that can be combined with the overwrap 80 may have a thinner wall, and thus, require less material and assembly, than a conventional cup having a multi-layered wall. In addition, if the container that is combined with the overwrap also includes a microstructure as discussed in conjunction with FIG. 1, then the amount of material that the container and overwrap consist of may be significantly less than other, conventional cups with conventional overwraps. Furthermore, if the container and overwrap are made of the same thermoplastic polymer material then they don't need to be separated and sorted before being recycled.

The shape of the overwrap 80 may be any desired shape that fits over a wall of a container. For example, in this and certain other embodiments the shape is cylindrical. More specifically, the shape of the overwrap 80 includes an inverted, truncated cone sized to slip over the bottom 34 (FIG. 2A), or 64 (FIG. 5). In other embodiments, the shape may include a truncated cone in which the top 84 of the overwrap 80 is dimensionally smaller than the bottom 86. In still other embodiments, the shape may be cylindrical with a rectangular cross-section, such as a pyramid.

Referring to FIG. 7B, to form the body 82 of the container 80, a first portion 88 of the body 82 is joined to a second portion 90 of the body 82. The two portions 88 and 90 may be joined to each other by any desired means. For example, in this and certain other embodiments, an adhesive (not shown) between the first and second portions 88 and 90, respectively, fastens the two portions together to form an inverted, truncated cone having the top 84 and the bottom 86. In this and certain other embodiments, the top 84 includes a lip 92 to facilitate drinking and/or pouring from a container that includes the overwrap 80. In other embodiments, an agent disposed between the two portions 88 and 90 may seal the two portions 88 and 90 to each other when heated to an activating temperature. In still other embodiments, the portions 88 and 90 may be fused together as described in the above-referenced PCT patent application PCT/US11/33075.

Other embodiments of the overwrap 80 are possible. For example, the body 82 of overwrap 80 may be formed by thermoforming a sheet of thermoplastic polymer material into a container similar to the container 60 show in FIGS. 7A and 7B; and then removing the bottom of the container 60.

As previously mentioned, the overwrap 80 may be releasably or fixedly joined to a wall of a container, such as the 32 (FIG. 2A) of container 30 (FIG. 2A) or the wall 62 (FIG. 5) of container 60 (FIG. 5). For example, in this and certain other embodiments the overwrap 80 may be slipped over the wail 32 or 62. In other embodiments the overwrap 80 may be fixedly joined to the wall 32 or 62 by any desired means. For example, an adhesive (not shown) between the surface 94 (FIG. 7B) and the outer surface of the wall 32 or 62 may fasten the overwrap 80 and container 30 or 60 together. Or, an agent disposed between the surface 94 and a container's outer surface may seal the two to each other when heated to an activating temperature. Or, the overwrap's surface 94 and a container's outer surface may be fused together as described in the above-referenced PCT patent application PCT/US11/33075.

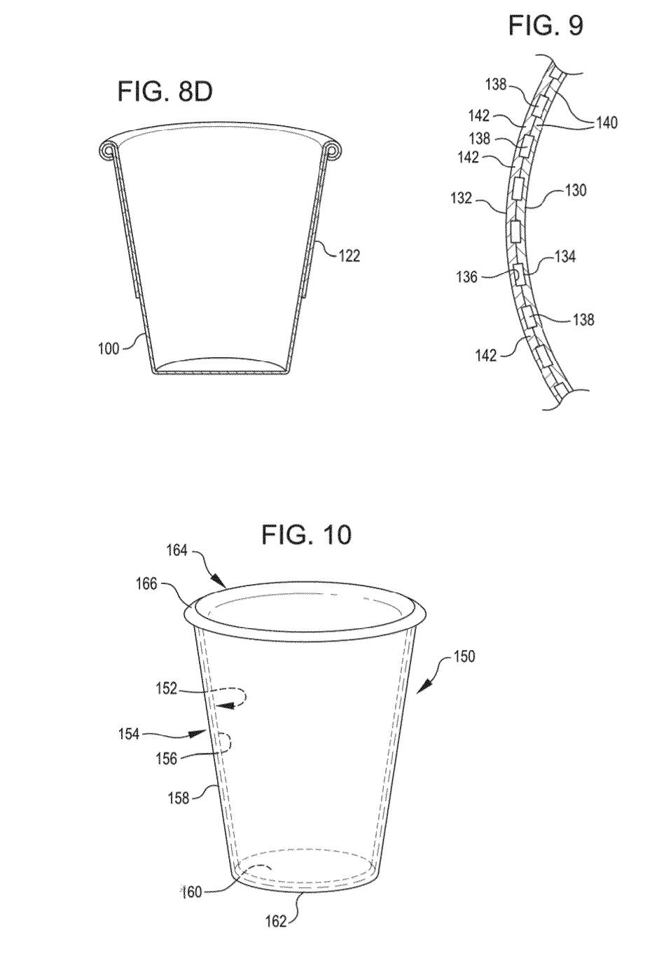

FIGS. 8A-8D are views of a respective one of four overwraps, each according to an embodiment of the invention, combined with a container, such as the container 30 (FIG. 2A) or the container 60 (FIG. 5).

FIG. 8A is a perspective view of a container 100 with an overwrap 102 joined to it according to an embodiment of the invention. The overwrap 102 is similar to the overwrap 80 discussed in conjunction with FIGS. 7A and 7B, and surrounds a middle portion of the container 100 where a person holding the container 100 would most likely grip the container 100 if the overwrap 102 were absent. In this and certain other embodiments, the overwrap 102 is configured to simply slip over the middle portion of the container 100 from below the container until the overwrap 102 contacts the container. In this manner, the overwrap may be quickly and easily combined with the container 100 to provide additional thermal insulation for a person's fingers, or other body parts, while the person holds the container, and/or provide messages via printed text and/or graphics that are targeted to the person based on the person's demographic, and/or specific taste or desire.

FIG. 86 is a cross-sectional view of a container 100 with an overwrap 104 joined to it, according to another embodiment of the invention. The overwrap 104 is similar to the overwrap 80 discussed in conjunction with FIGS. 7A and 76, surrounds much of the container 100, and is joined to the container 100 with an adhesive (not shown) as discussed in conjunction with FIGS. 7A and 76. In addition, the overwrap 104 includes a skirt 106 that extends below the bottom 108 of the container 100.

With the skirt 106, the overwrap 104 can provide the container additional stability, as discussed in conjunction with FIGS. 2A-3C, when the overwrap and container combination are placed on an uneven surface. In addition, the skirt 106 makes the bottom 108 a false bottom, which allows the container and overwrap combination to be easily de-nested or removed from its immediately adjacent neighbors in a stack of such containers. Both of these effects have typically been reasons for preferring a convolute-formed container over a thermoformed container in many situations. But, because the overwrap 104 can be combined with a thermoformed container, the combination of a thermoformed container and an overwrap 104 may be more desirable than a convolute-formed container for such situations. The overwrap 104 and thermoformed container may be produced quicker (each about 1,000 per minute) than a convolute-formed cup (about 200 cups per minute), and thus may be produced for less cost.

FIG. 8C is a cross-sectional view of a container 100 with an overwrap 110 joined to it, according to yet another embodiment of the invention. The overwrap 110 is similar to the overwrap 80 discussed in conjunction with FIGS. 7A and 7B, and surrounds most of the container 100. The overwrap 110 includes a skirt 112 that extends below the bottom 114 of the container 100, and a lip 116. The container 100 includes a lip 118. In this and certain other embodiments, the top portion of the container 100 and the overwrap 110 are rolled together such that the overwrap's lip 116 nests inside the container's lip 118. This helps support the container 100 by diverting some of the load that would otherwise be carried solely by the container's lip 118 to the overwrap's lip 116, and then distributing the load to the body 120 of the overwrap 110. Thus, some of the load from the container's lip 118 is not transferred to the side walls of the container 100. In other embodiments the overwrap 110 may be joined to the container 100 using any additional means as discussed in conjunction with FIGS. 7A and 7B.

FIG. 8D is a cross-sectional view of a container 100 with an overwrap 122 joined to it, according to still another embodiment of the invention. This overwrap and container combination is similar to the combination discussed in conjunction with FIG. 8C except the overwrap 122 does not include a skirt. This combination may be desirable when improved stability that a skirt offers is not that important, or when the load to be carried by the overwrap's lip and distributed to the overwrap's body does require the additional length in the body that a skirt provides.

FIG. 9 is a partial cross-sectional view of a container 130 with an overwrap 132 joined to it, according to another embodiment of the invention. The container 130 includes an outer surface 134 that is corrugated, and the overwrap 132 includes a inner surface 136 that is corrugated and configured such that the overwrap 132 may be joined to the container 130 to form an I-beam like structure. With such a structure, air pockets 138 may be formed that help the wall 140 of the container 130, and the body 142 of the overwrap 132, insulate the contents inside the cup and provide additional stiffness to the combination of the overwrap 132 and container 130.

In this and certain other embodiments, the overwrap 132 and the container 130, each, include a thermoplastic polymer material that has a microstructure as discussed in conjunction with FIG. 1, and the overwrap 132 is similar to the overwrap 80 discussed in conjunction with FIGS. 7A and 7B. The corrugations in the inner surface 136 of the overwrap 132 and the outer surface 134 of the container 130 may be formed by de-bossing or depressing regions of each of the surfaces 134 and 136 by rolling an embossed surface of a roller over each of the surfaces 134 and 136. The rolling step may be performed while the material is malleable, such as when the material is warmed to a malleable state, and may be performed before or after microcellular bubbles have been generated in the material's microstructure.

FIG. 10 is a perspective view of a container 150, according to another embodiment of the invention. The container 150 includes a first component 152 that nests in a second component 154. Each of the components 152 and 154 are similar to the container 60 discussed in conjunction with FIGS. 5 and 6. Each of the components 152 and 154 includes a wall 156 and 158, respectively, and a bottom 160 and 162, respectively. In this and certain other embodiments, each of the walls 156 and 158, and the bottoms 160 and 162 includes a thermoplastic polymer material that has a microstructure as discussed in conjunction with FIG. 1. More specifically, the microstructure includes a plurality of dosed cells 26 (FIG. 1), each cell 26 containing avoid and each cell 26 having a maximum dimension extending across the void within the cell 26 that ranges between 1 micrometer and 200 micrometers long. In other embodiments, each cell 26 may have a maximum dimension extending across the void within the cell 26 that ranges between 1 and 50 micrometers. With a smooth integral skin 24 (FIG. 1), one can print or emboss the surface of the wall 32 and/or bottom 34 that is exposed to a user.

Because the thermoformed container 150 includes two components 152 and 154, each including material having a microstructure as discussed in conjunction with FIG. 1, the container 150 is stiffer than the container 60 (FIG. 5) and conventional, disposable, thermoformed cups; and the container 150 provides more thermal insulation than the container 60 and conventional thermoformed cups. Thus, the container 150 can keep contents hot or cold longer than the container 60 and conventional, disposable thermoformed cups; and can keep one's hands better insulated from the temperature of the container's contents.

The shape of the container 150 may be any desired shape. For example, in this and certain other embodiments the shape is cylindrical. More specifically, the shape of the container 150 includes an inverted truncated cone. In other embodiments, the shape may include a truncated cone in which the opening of the container is smaller than the bottom. In still other embodiments, the shape may be cylindrical with a rectangular cross-section, such as a pyramid.

The container 150 may also include a lip 164. In this and certain other embodiments, the lip 164 includes a first lip (not shown) that is part of the first component 152, and a second lip 166 that is part of the second component 154. To form the lip 164, the top portion of the first component 152 and the top portion of the second component 154 are rolled together such that the lip formed in the first component 152 nests inside the lip 166 of the second component 154. In this and certain other embodiments, the first and second components 152 and 154, respectively, are joined by the lip 164. In other embodiments the first and second components 152 and 154, respectively may be joined together using any additional means as discussed in conjunction with FIGS. 7A and 78.

Other embodiments are possible. For example, containers that include a thermoplastic polymer material having a microstructure as discussed in conjunction with FIG. 1 can also be made via injection molding and/or blow molding. As another example, a container 150 may be thermoformed as previously discussed and then cut to remove its bottoms 160 and 162 so that a bottom 36 (FIG. 3C) may be joined as previously discussed.

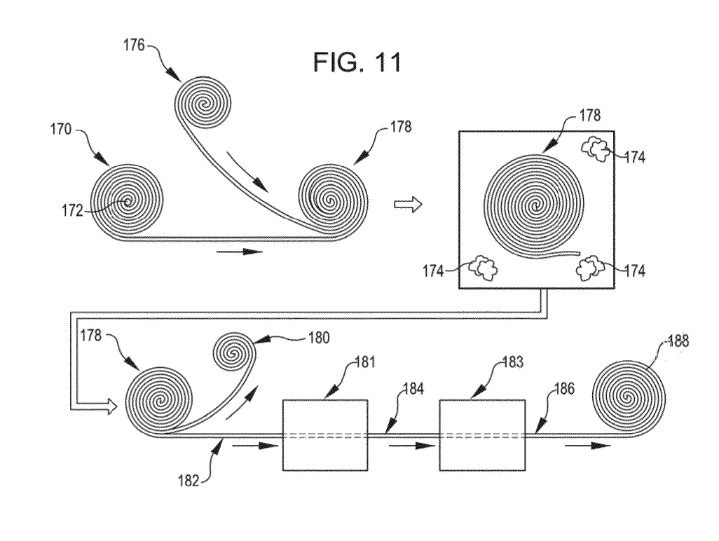

FIG. 11 is a schematic view of a process for generating a closed-cell microstructure in a thermoplastic polymer material such as that shown in FIG. 1, according to an embodiment of the invention. Although the process shown and discussed in conjunction with FIG. 11 is a semi-continuous process in which the material moves as its microstructure is generated, much like a car moving in an assembly line as the car is made, the process for forming the microstructure may not be semi-continuous. In such an example, the material may remain stationary as its microstructure is generated and only move from one processing station to another.

Referring to FIG. 11, in this and other embodiments, a process for generating the closed-cell microstructure 22 (FIG. 1) in a thermoplastic polymer material 170 includes dissolving into the polymer 170 (here shown as a film rolled around a drum 172, but may be a block or thin sheet) a gas 174 that does not react with the polymer 170. The process also includes making the polymer 170 with the dissolved gas thermodynamically unstable at a temperature that is or close to the polymer and dissolved gas combination's glass transition temperature—the temperature at which the polymer 170 is easily malleable but has not yet melted. With the temperature at or near the glass transition temperature, bubbles 26 (FIG. 1) of the gas 174 can nucleate and grow in regions of the polymer 170 that are thermodynamically unstable—i.e. supersaturated. When the bubbles 26 have grown to a desired size, the temperature of the polymer 170 is reduced below the glass transition temperature to stop the bubbles' growth, and thus provide the polymer 170 with a microstructure having closed-cells whose size may range between 1 and 200 μm long.

In the process, the first step is to dissolve into the polymer 170 any desired gas 174 that does not react with the polymer 170. For example, in this and certain other embodiments of the process, the gas 174 may be carbon dioxide (CO₂) because CO₂ is abundant, inexpensive, and does not react with PET. In other embodiments of the process, the gas may be nitrogen and/or helium. Dissolving the gas 174 into the polymer 170 may be accomplished by exposing the polymer for a period of time to an atmosphere of the gas 174 having a temperature and a pressure. The temperature, pressure, and period of time may be any desired temperature, pressure, and period of time to dissolve the desired amount of gas 174 into the polymer 170. The amount of gas 174 dissolved into the polymer 170 is directly proportional to the pressure of the gas 174 and the period of time that the polymer 170 is exposed to the gas 174 at a specific temperature and specific pressure, but is inversely proportional to the temperature of gas 174. For example, in this and certain other embodiments, the temperature may be 72° Fahrenheit, the pressure may be 725 pounds per square inch (psi), and the duration of the period may be 10 hours. This typically saturates the polymer 170 with the gas 174. In other embodiments, the pressure may range between 500 psi and 1000 psi, and the duration of the period may range between 4 hours and 24 hours.

Because the layers of the rolled polymer film 170 that lie between adjacent layers or between a layer and the drum 172 are substantially unexposed to the atmosphere when the roll is placed in the atmosphere, a material 176 is interleaved between each layer of the rolled polymer film that exposes each layer to the atmosphere. In this and certain other embodiments, the material 176 includes a sheet of cellulose, and is disposed between each layer of the polymer film 170 by merging the sheet with the film and then rolling the combination into a single roll 178. The material 176 exposes each layer of the polymer film 170 by allowing the gas to easily pass through it. After the gas 174 has saturated the polymer film 170, the material 176 may be removed from the roll 178 and saved as a roll 180 for re-use.

The next step in the process includes exposing the polymer film 170 with the dissolved gas to an atmosphere having less pressure than the one in the first step to cause the combination of the polymer film 170 and the gas dissolved in the polymer film 170 to become thermodynamically unstable i.e. the whole polymer or regions of the polymer to become supersaturated with the dissolved gas. For example, in this and certain other embodiments, the reduction in pressure may be accomplished by simply exposing the polymer film 170 to atmospheric pressure, which is about 14.7 psi, in the ambient environment.

When the combination of the polymer film 170 and the dissolved gas becomes thermodynamically unstable, the dissolved gas tries to migrate out of the film 170 and into the ambient environment surrounding the film 170. Because the dissolved gas in the interior regions of the polymer film 170 must migrate through the regions of the polymer film 170 that are closer to the film's surface to escape from the polymer film 170, the dissolved gas in the interior regions begins to migrate after the dissolved gas in the surface regions begins to migrate, and takes more time to reach the ambient environment surrounding the polymer film 170 than the dissolved gas in the film's regions that is closer to the film's surface. Thus, before heating the polymer film 170 to a temperature that is or is close to its glass transition temperature, one can modify the concentration of dissolved gas in regions of the polymer film 170 by exposing the polymer film 170 to an atmosphere having less pressure than the one in the first step for a period of time. Because the concentration of dissolved gas depends on the amount of gas that escapes into the ambient environment surrounding the polymer film 170, the concentration of dissolved gas is inversely proportional to the period of time that the film 170 is exposed to the low-pressure atmosphere before being heated to its or close to its glass transition temperature.

In this manner, a skin, such as the skin 24 (FIG. 1), may be formed in the polymer film 170 when the film 170 is heated to a temperature that is or is close to its glass transition temperature. For example, in this and certain other embodiments, the roll 178 of polymer film and interleaved material 176 can remain in a thermodynamically unstable state for a period of time before removing the material 176 from the roll 178 and heating the film. This allows some of the gas dissolved in the region of the film adjacent the film's surface to escape. With the gas absent from this region of the film, this region becomes more thermodynamically stable than the regions that are further away from the film's surface. With a sufficient amount of thermodynamic stability in the region, bubbles won't nucleate in the region when the film is heated close to its glass transition temperature. Consequently, closed cells 26 (FIG. 1) can be omitted from this region of the film, leaving a solid portion of the microstructure that is integral to the closed cell portion of the microstructure, such as the skin 24 (FIG. 1). Because the thickness of the skin 24 or solid portion depends on the absence of dissolved gas in the region of the film 170, the thickness of the skin 24 or solid portion is directly proportional to the period of time that the film 170 spends in a thermodynamically unstable state before being heated to or substantially close to its glass transition temperature. In this and certain other embodiments, the thickness of the integral skin ranges 5-200 μm.

The next step 181 in the process is to nucleate and grow bubbles 26 (FIG. 1) in the polymer 182 to achieve a desired relative density for the polymer film 182. Bubble nucleation and growth begin about when the temperature of the polymer film 182 is or is close to the glass transition temperature of the polymer film 182 with the dissolved gas. The duration and temperature at which bubbles 26 are nucleated and grown in the polymer 182 may be any desired duration and temperature that provides the desired relative density. For example, in this and certain other embodiments, the temperature that the PET polymer is heated to is approximately 200°-280° Fahrenheit, which is about 40°-120° warmer than the glass transition temperature of the polymer without any dissolved gas. The PET film 182 is held at approximately 200°-280° Fahrenheit for approximately 30 seconds. This provides a relative density of the closed-cell film of about 18.5%. If the PET film 182 is held at 200°-280° Fahrenheit for a period longer than 30 seconds, such as 120 seconds, then the bubbles 26 grow larger, and thus the size of resulting closed cells are larger. This may provide a relative density of the closed cell film of about 10%-20%. If the PET film 182 is held at 200°-280° Fahrenheit for a period shorter than 30 seconds, such as 10 seconds, then the bubbles 26 remain small, and thus the size of resulting closed cells are smaller. This may provide a relative density of the closed cell film of about 40%.

To heat the polymer film 182 that includes the dissolved gas, one may use any desired heating apparatus. For example, in this and certain other embodiments, the PET film 182 may be heated by a roll fed flotation/impingement oven, disclosed in the currently pending U.S. patent application Ser. No. 12/423,790, titled ROLL FED FLOTATION/IMPINGEMENT AIR OVENS AND RELATED THERMOFORMING SYSTEMS FOR CORRUGATION-FREE HEATING AND EXPANDING OF GAS IMPREGNATED THERMOPLASTIC WEBS, filed 14 Apr. 2009, and incorporated herein by this reference. This oven suspends and heats a polymer film that moves through the oven, without restricting the expansion of the film.

The next step 183 in the process includes reducing the temperature of the heated polymer 184, and thus the malleability of the polymer 184 that occurs at or near the glass transition temperature, to stop the growth of the bubbles 26. At this point the polymer film 186 includes a closed-cell microstructure such as that shown in FIG. 1 and may be spooled back into a roll 188 for future use. The temperature of the heated polymer may be reduced using any desired technique. For example, in this and certain other embodiments, the polymer film 184 may be left to cool at ambient room temperature—i.e. simply removed from the heating apparatus. In other embodiments the heated polymer film 184 may be quenched by drenching it with cold water, cold air, or any other desired medium.

Other embodiments of the process are possible. For example, the polymer film 182 can be heated to a temperature that is or close to its glass transition temperature when the polymer film 182 is initially exposed to an atmosphere that causes the gas dissolved in the polymer film 182 to become thermodynamically unstable. This allows one to make a film that does not include a skin or includes a skin having a minimal thickness.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

1.-53. (canceled)

54. A method for forming an overwrap to a container for holding a beverage and/or other items, the method comprising:
joining a first portion of a body to a second portion of the body to form a shape having two ends, each end being open, wherein the body includes a thermoplastic polymer having a microstructure that includes a plurality of dosed cells, each cell containing a void and each cell having a maximum dimension extending across the void within the cell that ranges between 1 micrometer and 200 micrometers long.

55. The method of claim 54 wherein joining the first portion of the body to the second portion of the body includes:
applying an adhesive to the first portion, and
pressing the second portion against the adhesive.

56. The method of claim 54 wherein joining the first portion of the body to the second portion of the body includes exerting pressure on the first and second portions to form a bond that holds the portions together.

57. The method of claim 54 wherein:
each dosed cell includes a gas in the void that exerts pressure inside the cell, and
while pressure is exerted on the body portions to form a bond that holds the portions together, the pressure inside a plurality of the cells is equal to or greater than the pressure exerted on the portions.

58. The method of claim 54 wherein joining the first portion of the body to the second portion of the body includes:
heating a surface of the first portion to melt material at the surface, and
exerting pressure on the first and second portions to fuse the surface to the second portion.

59. The method of claim 54 further comprising forming a lip in the overwrap.

60. The method of claim 54 further comprising forming a lip in the overwrap configured to nest in a lip of a container while the overwrap is joined to the container.

61. The method of claim 54 further comprising forming a skirt in the overwrap, wherein the skirt extends beyond a bottom of a container while the overwrap is joined to the container.

62. The method of claim 54 further comprising corrugating an inside surface of the body.

63. An overwrap for a container to hold a beverage and/or other items, the overwrap comprising:
a body having a shape and configured to surround a portion of a container, wherein the body includes a thermoplastic polymer material having a microstructure that includes a plurality of dosed cells, each cell containing a void and each cell having a maximum dimension extending across the void within the cell that ranges between 1 micrometer and 200 micrometers long.

64. The overwrap of claim 63 wherein the plurality of closed cells each has a maximum dimension that ranges between 1 micrometer and 50 micrometers.

65. The overwrap of claim 63 wherein the microstructure of the body's material includes a solid skin that defines an interior surface of the wall.

66. The overwrap of claim 63 wherein an adhesive between a first and a second portion of the body joins the first and second portions together to form the shape.

67. The overwrap of claim 63 wherein a first portion of the body is fused to a second portion of the body to form the shape.

68. The overwrap of claim 63 wherein the shape is cylindrical.

69. The overwrap of claim 63 wherein the shape includes a truncated cone.

70. The overwrap of claim 63 further comprising a lip.

71. The overwrap of claim 63 further comprising a lip configured to nest in a lip of a container while the overwrap is joined to the container.

72. The overwrap of claim 63 further comprising a skirt, wherein the skirt extends beyond a bottom of a container while the overwrap is joined to the container.

73. The overwrap of claim 63 wherein the body includes an inside surface that includes a corrugation.

74.-87. (canceled)
